(19) United States
(12) Patent Application Publication
(10) Pub. No.: US 2018/0248831 A1
(43) Pub. Date: Aug. 30, 2018

(54) METHODS AND SYSTEMS FOR ELECTRONIC MESSAGING MANAGEMENT

(71) Applicant: DAVID FLETCHER, ORLEANS (CA)

(72) Inventor: DAVID FLETCHER, ORLEANS (CA)

(21) Appl. No.: 15/904,752

(22) Filed: Feb. 26, 2018

Related U.S. Application Data
(60) Provisional application No. 62/463,192, filed on Feb. 24, 2017.

(51) Int. Cl. H04L 12/58

(52) U.S. Cl. CPC H04L 51/26; H04W 4/14; H04L 51/22; H04L 51/12

(57) ABSTRACT

We receive messages today through multiple channels such as telephone, texts, emails, social media posts etc. and can struggle to prioritize, miss messages, etc. which can impact sales, service, and other customer orientated activities within businesses, service providers etc. Embodiments of the invention exploit a communication model wherein the conventional delay is augmented with filters, recirculating delay lines, decision circuits and loads to exploit an electrical analogy. This model allows different priority messages to be handled and recognizes that messages have different priorities associated with them and that these priorities are dynamic and do not necessarily depend solely upon the sender and recipient but also the context of that communication within an overall activity. Beneficially, the model is compatible with a variety of enterprise software tools including, but not limited, lead management (LM), sales management (SM), customer relationship management (CRM), as well as electronic mail and other communication tools etc.

### CROSS-REFERENCE TO RELATED APPLICATIONS

This patent application claims the benefit of priority from U.S. Patent Application 62/463,192 filed Feb. 24, 2017 entitled “Methods and Systems for Electronic Messaging Management”, currently pending, the entire contents of which are incorporated herein by herein by reference.

### FIELD OF THE INVENTION

This invention relates to electronic content and more particularly to integrated front-end electronic communication and lead management systems supporting dynamic real-time prioritization.

### BACKGROUND OF THE INVENTION

Communication is the exchange of thoughts, messages, or information, as by speech, visuals, signals, writing, or behavior. It requires a sender, a message, and a recipient, although the receiver does need not be present or aware of the sender's intent to communicate at the time of communication and therefore communication can occur across wide ranges of distances in both time and space. Communication requires that the communicating parties share an area of communicative commonality and maybe considered complete either once the receiver has understood the message of the sender or has acknowledged / or responded to the sender.

Within the prior art models allowing one-way, two-way, and multi-way conversations have been established, analysed and implemented within telecommunications infrastructure across multiple communications technologies to perform the transmitter, channel, and receiver such as wireless, wired, and fiber optic. Today, such models support multiple communication formats including, for example, voice (e.g. Plain Old Telephone Service (POTS) or Voice-over-Internet Protocol (VOIP)), electronic mail (email), Short Message Service (SMS or text), “Tweeting” (using social media network Twitter™), as well as “posting” (to social media etc.). Such models consider the interactions between sender and recipient as a single process and that other aspects of the communications channel such as voicemail, email server, and text server that store the senders message prior to the recipient's receipt are modeled as a delay within the communications channel.

However, going back to the primary definition of communication is the exchange of thoughts, messages, or information and accordingly these models and their physical implementations fall short in that they do not provide for additional aspects of the communication process such as acknowledgement and verification, for example. Accordingly, embodiments of the invention establish a communication model wherein in addition to delay the model supports filters, recirculating delay lines, decision circuits and loads to exploit an electrical analogy. As such a message can be filtered to lead to a particular route within the communications network, held within memory pending a decision to progress it, or provided to a load such as the recipient, a junk folder, or a waste bin. Additionally, the model supports communications that may have different priorities associated with them and that these priorities are not necessarily static factors but ones that are dynamic and do not necessarily depend solely upon the sender and recipient but the context of that communication within an overall activity relating to the sender, the recipient, and activity.

It would be beneficial for embodiments of the invention to be compatible with a variety of enterprise software tools including, but not limited, lead management (LM), sales management (SM), customer relationship management (CRM), as well as electronic mail and other communication tools etc. These LM, SM, and CRM software tools seek to create an ordered structure for managing communications using previous communication models but can through embodiments of the invention be adapted to the more complex models. For example, some such as Lewinson et al in “Methods and Systems for Delayed Notifications in Communications Networks” (U.S. Pat. No. 9,571,429) seek to break the immediate transmission model of prior art communications by supporting in-line programmable delay as well as supporting enhanced sender side analytics and decision making. Alternatively, von Teichman et al. in “Dynamic Contact Management Systems and Methods” (U.S. Patent Application No. 2016/0,148,215) seeks to provide dynamic receiver side address assignment and filtering within LM software to direct received messages based upon factors such as received communication channel, time/date, etc. The inventive model is compatible with such extensions of the prior art simplistic model of linear transmission by supporting complex communication path models with dynamic context-based rules.

It would be further beneficial for embodiments of the invention to support requirements of micro, small and medium enterprises (MSMEs) (European Community definitions for MSMEs being enterprises with up to 10, 50 and 250 employees respectively) with diverse requirements and support the larger number of communication formats exploited today by both senders and recipients such as voice, email and text, for example, via fixed and/or portable electronic devices.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations within the prior art relating electronic content and more particularly to integrated front-end electronic communication and lead management systems supporting dynamic real-time prioritization.

In accordance with an embodiment of the invention there is provided a method comprising:

automatically receiving an electronic message from a sender to be provided to a recipient;
assigning a priority to the electronic message in dependence upon a context of the recipient

established by a server upon which the electronic message is received; and establishing a messaging process from a plurality of messaging processes in dependence upon

the priority assigned to the received electronic message.

In accordance with an embodiment of the invention there is provided a method of prioritizing electronic communications to a recipient from senders by assigning each electronic communication received to a messaging process established in dependence upon the current context of the recipient.

In accordance with an embodiment of the invention there is provided a method of electronic communication wherein a received electronic communication for a recipient from a sender is assigned a priority established in dependence upon the current context of the recipient and the recipient can view other priorities of other recipients of the received electronic communication.

In accordance with an embodiment of the invention there is provided a method of electronic communication wherein a sender of an electronic communication to an intended recipient is provided with a response established in dependence upon a context of the intended recipient.

In accordance with an embodiment of the invention there is provided a method of prioritizing delivery of an electronic communication to an intended recipient of the electronic communication in dependence upon a current context of the intended recipient established at the time of receipt of the electronic communication.

In accordance with an embodiment of the invention there is provided a method of presenting electronic communications to a user comprising:

automatically receiving electronic messages from senders to be provided to a recipient;
assigning to each received electronic message a priority established in dependence upon a context of the recipient established by a server at the time of receipt of the received electronic message;
assigning each received electronic message to a messaging process of a plurality of messaging processes in dependence upon the priority assigned to the received electronic message; and
providing the user with those received electronic messages within a predetermined messaging process having the highest priority.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which embodiments of the invention may be employed;

FIG. 2 depicts a wireless portable electronic device supporting communications to a network such as depicted in FIG. 1 and as supporting embodiments of the invention;

FIG. 3 depicts a flowchart relating to a recipient side communications model according to an embodiment of the invention;

FIG. 4 depicts a flowchart relating to a recipient side communications model according to an embodiment of the invention; and

FIG. 5 depicts a flow chart relating to recipient side communications model transitioning according to an embodiment of the invention.

### DETAILED DESCRIPTION

The present invention is directed to electronic content and more particularly to integrated front-end electronic communication and lead management systems supporting dynamic real-time prioritization.

The ensuing description provides representative embodiment(s) only and is not intended to limit the scope, applicability or configuration of the disclosure. Rather, the ensuing description of the embodiment(s) will provide those skilled in the art with an enabling description for implementing an embodiment or embodiments of the invention. It is being understood that various changes can be made in the function, and arrangement of elements without departing from the spirit and scope as set forth in the appended claims. Accordingly, an embodiment is an example or implementation of the inventions and not the sole implementation. Various appearances of “one embodiment”, “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristics described in connection with the embodiments is included in at least one embodiment, but not necessarily all embodiments, of the inventions. The phraseology and terminology employed herein are not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristics “may”, “might”, “can” or “could” be included, that particular component, feature, structure, or characteristics are not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users. Reference to terms “including”, “comprising”, “consisting” and grammatical variants thereof do not preclude the addition of one or more components, features, steps, integers or groups thereof, and that the terms are not to be construed as specifying components, features, steps or integers. Likewise, the phrase “consisting essentially of”, and grammatical variants thereof, when used herein is not to be construed as excluding additional components, steps, features, integers or groups thereof, but rather that the additional features, integers, steps, components or groups thereof do not materially alter the basic and novel characteristics of the claimed composition, device or method. If the specification or claims refer to “an additional” element, that does not preclude there being more than one of the additional elements.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a wireless and /or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™)

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third-party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals whose biometric data may be, but not limited to, monitored, acquired, stored, transmitted, processed and analysed either locally or remotely to the user wherein by their engagement with a service provider, third party provider, enterprise, social network, social media etc. via a dashboard, web service, website, software plug-in, software application, graphical user interface acquires, for example, electronic content. This includes, but is not limited to, private individuals, employees of organizations and/or enterprises, members of community organizations, members of charity organizations, men, women, children, and teenagers.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

Reference to “content information” as used herein may refer to, but is not limited to, any combination of content features, content serving constraints, information derivable from content features or content serving constraints (referred to as “content derived information”), and/or information related to the content (referred to as “content related information”), as well as an extension of such information (e.g., information derived from content related information).

Reference to a “document” as used herein may refer to, but is not limited to, any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.). In the context of the Internet, a common document is a Web page. Web pages often include content and may include embedded information (such as meta-information, hyperlinks, etc.) and/or embedded instructions (such as Javascript, etc.). In many cases, a document has a unique, addressable, storage location and can therefore be uniquely identified by this addressable location such as a universal resource locator (URL) for example used as a unique address used to access information on the Internet.

“Document information” as used herein may refer to, but is not limited to, may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

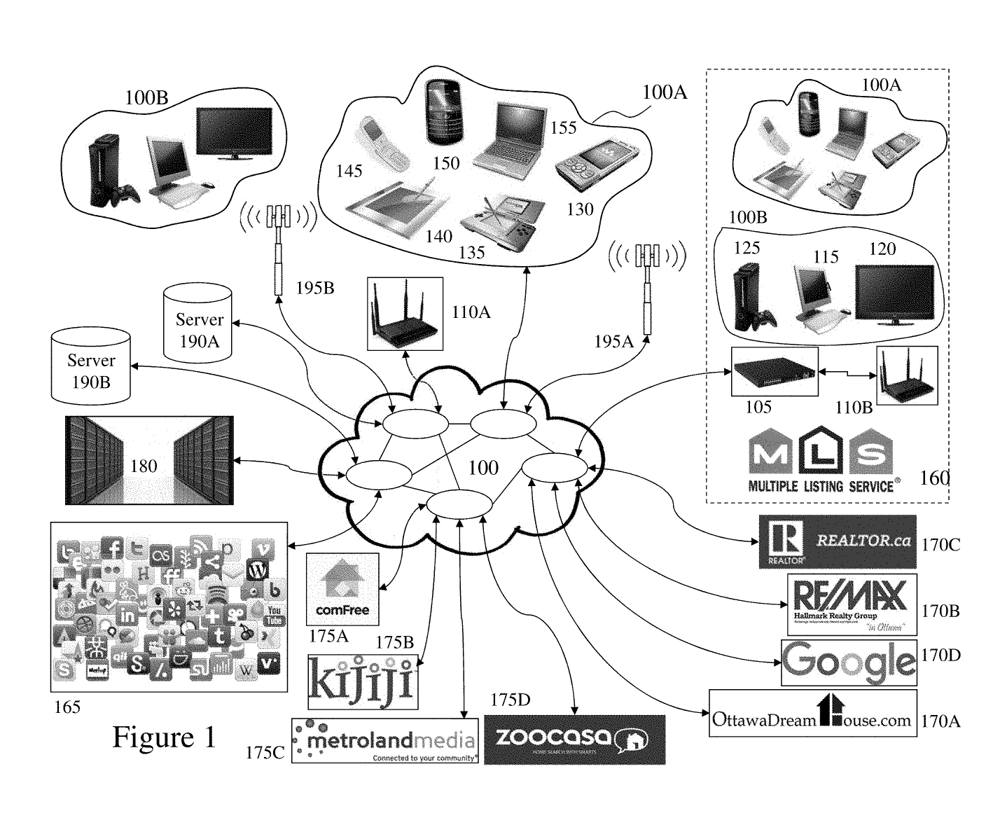

Within the embodiments of the invention described and depicted below in respect of FIGS. 1 to 4 these are described primarily from the viewpoint of a realtor/real estate MSME such as a real estate brokerage. However, it would be evident that Electronic Content Systems and Electronic Content Applications/Platforms (ECS-ECAPs) according to embodiments of the invention may be exploited by other MSMEs within a variety of industries including, but not limited to, those within Entertainment, Government, Telecommunications, Hospitality Industry/Tourism, Mass Media, Healthcare/Hospitals, Public Health, Information Technology, Waste Disposal, Financial Services, Banking, Insurance, Investment Management, Consumer Goods, Professional Services, Accounting, Legal Services, Gambling, Retail Sales, Franchising, Real Estate, Education etc. and other elements of the service sector (tertiary sector) of the economy, i.e. activities where people offer their knowledge and time to improve productivity, performance, potential, and sustainability, what is termed affective labor. The basic characteristic of this sector is the production of services instead of end products. MSMEs may also provide services commonly referred to as “intangible goods” include attention, advice, access, experience, and discussion.

However, it would be evident that MSMEs may also be within the secondary sector of the economy which is generally considered to be those portions of the economy that create a finished, usable product by either is direct production or construction. Similarly, MSMEs may also be within the primary sector of the economy which is generally considered to be those portions of the economy making direct use of natural resources. This includes, but is not limited to, agriculture, forestry, fishing and mining. Manufacturing industries that aggregate, pack, package, purify or process raw materials close to the primary producers are normally considered part of this sector, especially if the raw material is unsuitable for sale or difficult to transport long distances. Optionally, a MSME may be defined sub-division, subsidiary, parent organization, division, department, etc. of a large organization operating at regional, state, provincial, national, international level.

Referring to FIG. 1 there is depicted a network environment 100 within which embodiments of the invention may be employed supporting Electronic Content Systems and Electronic Content Applications/Platforms (ECS-ECAPs) according to embodiments of the invention. Such ECS-ECAPs, for example, supporting multiple communication channels, dynamic filtering, etc. As shown first and second user groups 100A and 100B respectively interface to a telecommunications network environment 100. Within the representative telecommunication architecture, a remote central exchange 180 communicates with the remainder of a telecommunication service provider's network via the network environment 100 which may include for example long-haul OC-48/OC-192 backbone elements, an OC-48 wide area network (WAN), a Passive Optical Network, and a Wireless Link. The central exchange 180 is connected via the network environment 100 to local, regional, and international exchanges (not shown for clarity) and therein through network environment 100 to first and second cellular APs 195A and 195B respectively which provide Wi-Fi cells for first and second user groups 100A and 100B respectively. Also connected to the network environment 100 are first and second Wi-Fi nodes 110A and 110B, the latter of which being coupled to network environment 100 via router 105. Second Wi-Fi node 110B is associated with Enterprise 160, e.g. Multiple Listing Service™, comprising other first and second user groups 100A and 100B. Second user group 100B may also be connected to the network environment 100 via wired interfaces including, but not limited to, DSL, Dial-Up, DOCSIS, Ethernet, G·hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network environment 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the network environment 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 and Bluetooth as well in an ad-hoc manner.

Also connected to the network environment 100 are Social Networks (SOCNETS) 165, first and second service providers 170A and 170B respectively, e.g. OttawaDreamHouse™ and RE-MAX™, first and second service providers 170C and 170D respectively, e.g. Realtor.ca™ and Google™. Also connected to the network environment 100 are first to fourth feed networks 175A to 175D respectively, e.g. comFree™, Kijiji™, MetrolandMedia, and Zoocasa™ together with others, not shown for clarity. Accordingly, an MSME such as first service provider 170A engages with multiple users, e.g. seller and buyers of residential and/or commercial properties or renters/rentees of rental residential and/or commercial properties as well as other brokers, agents, etc. wherein these may include those within their own organization, e.g. first service provider 170A (OttawaDreamHouse™), another associated organization, e.g. second service provider 170B (RE-MAX™), or other service providers such as first and second service providers 170C and 170D respectively and first to fourth feed networks 175A to 175D respectively. In addition, information relating to properties, the first service provider 170A, or a specific realtor within first service provider 170A may be obtained from one or more social networks such as Linkedln™, Facebook™, etc.

Also depicted are first and second servers 190A and 190B may host according to embodiments of the inventions multiple services associated with a provider of contact management systems and contact management applications/platforms (ECS-ECAPs); a provider of a SOCNET or Social Media (SOME) exploiting ECS-ECAP features; a provider of a SOCNET and/or SOME not exploiting ECS-ECAP features; a provider of services to PEDS and/or FEDS; a provider of one or more aspects of wired and/or wireless communications; an Enterprise 160 such as Multiple Listing Service (MLS) exploiting ECS-ECAP features; license databases; content databases; image databases; content libraries; customer databases; websites; and software applications for download to or access by FEDs and/or PEDs exploiting and/or hosting ECS-ECAP features. First and second primary content servers 190A and 190B may also host for example other Internet services such as a search engine, financial services, third party applications and other Internet based services.

Accordingly, a consumer and/or customer (CONCUS) may exploit a PED and/or FED within an Enterprise 160, for example, and access one of the first or second primary content servers 190A and 190B respectively to perform an operation such as accessing/downloading an application which provides ECS-ECAP features according to embodiments of the invention; execute an application already installed providing ECS-ECAP features; execute a web based application providing ECS-ECAP features; or access content. Similarly, a CONCUS may undertake such actions or others exploiting embodiments of the invention exploiting a PED or FED within first and second user groups 100A and 100B respectively via one of first and second cellular APs 195A and 195B respectively and first Wi-Fi nodes 110A. It would also be evident that a CONCUS may, via exploiting network environment 100 communicate via telephone, fax, email, SMS, social media, etc.

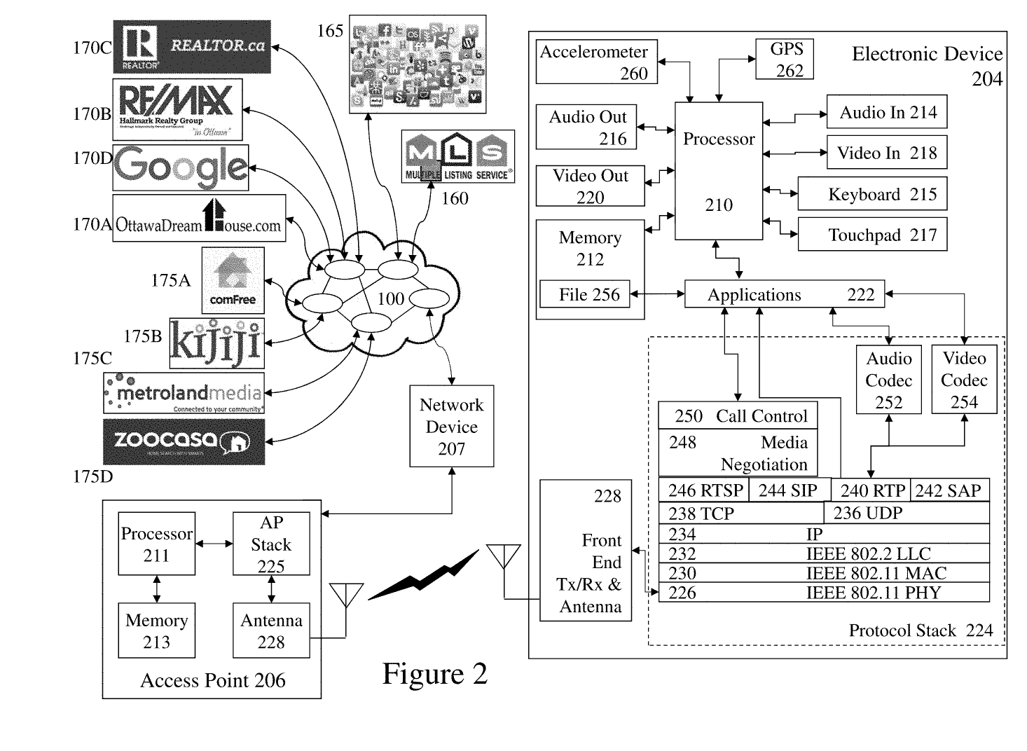

Now referring to FIG. 2 there is depicted an electronic device 204 and network access point 207 supporting ECS-ECAP features according to embodiments of the invention. Electronic device 204 may, for example, be a PED and/or FED and may include additional elements above and beyond those described and depicted. Also depicted within the electronic device 204 is the protocol architecture as part of a simplified functional diagram of a system 200 that includes an electronic device 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to network environment 100 and therein Social Networks (SOCNETS) 165, first and second service provider networks 170A and 170B respectively, e.g. RE/MAX™ and Royal LePage™, first and second service providers 170C and 170D respectively, e.g. Locations North and Doug Gillis, parts of the first and second service provider networks 170A and 170B respectively and first to fourth feed networks 175A to 175D respectively, e.g. comFree™, Kijiji™, MetrolandMedia, and Zoocasa™ together with others, not shown for clarity.

The electronic device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random-access memory devices (NVRAM), SDRAM, DRAM, double data rate (DDR) memory devices, SRAM, universal serial bus (USB) removable memory, and the like.

Electronic device 204 may include an audio input element 214, for example a microphone, and an audio output element 216, for example, a speaker, coupled to any of processors 210. Electronic device 204 may include a video input element 218, for example, a video camera or camera, and a video output element 220, for example an LCD display, coupled to any of processors 210. Electronic device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the electronic device 204. The one or more applications 222 that are typically stored in memory 212 and are executable by any combination of processors 210. Electronic device 204 also includes accelerometer 260 providing three-dimensional motion input to the process 210 and GPS 262 which provides geographical location information to processor 210.

Electronic device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the electronic device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G·hn, ISDN, MoCA, PON, and Power line communication (PLC).

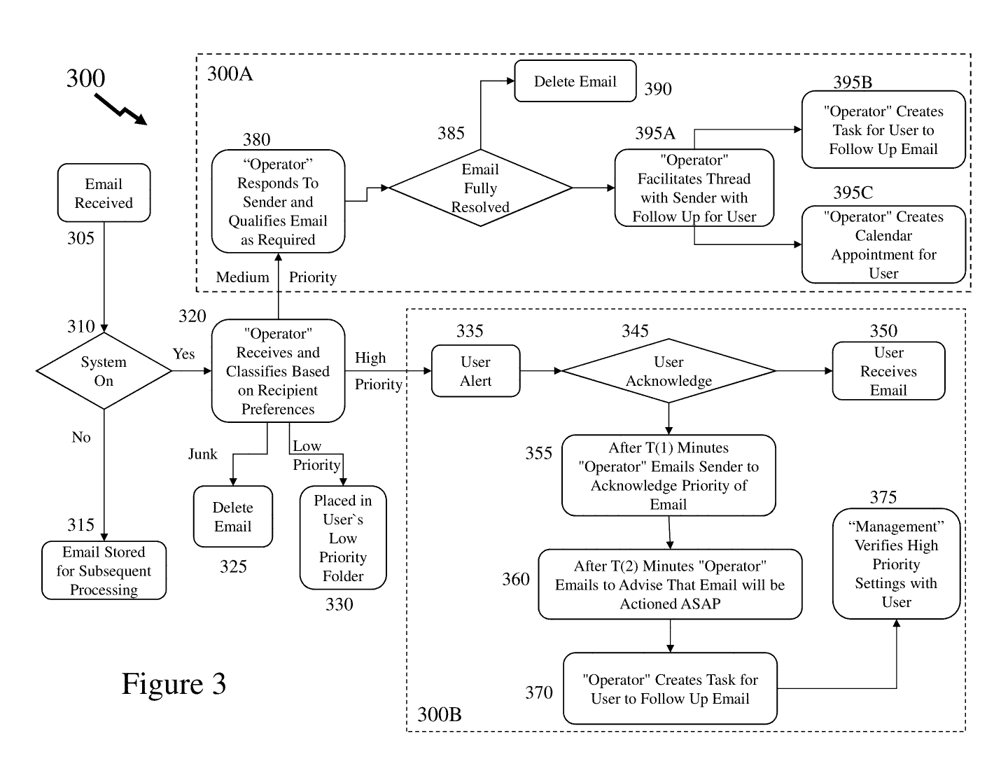

Now referring to FIG. 3 there is depicted a flowchart for a process 300 relating to a recipient side communications model according to an embodiment of the invention executed by an ECS-ECAP. At step 305 the process begins with receipt of an email wherein the process proceeds to step 310 wherein a determination as to whether the system is active or not wherein upon a determination that the system is active the process proceeds to step 320 otherwise it proceeds to step 315 wherein the email is stored for subsequent processing. At step 320 the received email is processed by an operator to determine a classification for the email based upon preferences associated with the recipient. Accordingly, the operator assigns the classification as “Junk”, “Low Priority”, “Medium Priority” or “High Priority.” Within an embodiment of the invention the operator may be an automated agent forming part of an ECS-ECAP performing an automated preference assignment based upon whether matches are made or not within predetermined fields within the received email such as subject, sender name, etc. based upon preferences set by the recipient as known within the prior art. Alternatively, within another embodiment of the invention an operator assigns a priority to the email based upon performing the same process of checking predetermined fields within the email with preferences set by the recipient, for example, by selecting a flag of a plurality of flags displayed to the operator within a pop-up or other indication—selection means known in the art wherein the ECS-ECAP subsequently processes the email based upon the flag assigned. Based upon the assigned classification the process 300 proceeds as follows:
A “Junk” flag makes the process proceed to step 325 wherein the ECS-ECAP deletes the email;
A “Low Priority” flag makes the process proceed to step 330 wherein the ECS-ECAP transfers the email into a low priority folder of the user;
A “Medium Priority” flag makes the process proceed to a first sub-flow 300A comprising steps 380 to 395B respectively; and
A “High Priority” flag makes the process proceed to a second sub-flow 300B comprising steps 335 to 375 respectively.

Referring to first process flow 300A the process comprises an initial step 380 wherein the “operator” responds to the sender and qualifies the email as required—appropriate wherein the process proceeds to step 385 wherein a determination is made as to whether the email has been fully resolved. A determination that the email has been fully resolved leads the process to step 390 wherein the email is deleted. Alternatively, the email may be archived or directed to a folder associated with the sender or based upon a preference established by the recipient/enterprise in dependence upon factors such as sender, email subject matter etc. If the email has not been fully resolved the process proceeds to step 395A wherein the “operator” facilitates a thread with the sender in order to establish follow-up with user (recipient) via steps 395B or 395C. In step 395B the “operator” creates a task for the user to follow up the email. In step 395C the “operator” creates a calendar appointment for the user to follow up the email.

Referring to first process flow 300B the process comprises an initial step 335 wherein the user is sent an alert relating to the email before proceeding to step 345 wherein a determination is made as to whether the user acknowledges the alert or not. Upon receipt of an acknowledgement to the alert in step 345 the process proceeds to step 350 wherein the user receives the email. If the user does not acknowledge within a predetermined period of time, T(1) (e.g. T(1)=30 minutes), then the process proceeds to step 355 wherein the “operator” sends a reply to the sender acknowledging the priority of the email sent by the sender and the process proceeds to step 360. In step 360 if the user has not acknowledged within a predetermined period of time, T(2) (e.g. T(2)=120 minutes), then the “operator” sends a reply to the sender acknowledging the priority of the email sent and then in step 370 the “operator” creates a task for the user to follow up the email and then proceeds to step 375 wherein “management” verifies the high priority settings of the email for the sender.

Accordingly, the routing of emails within the process flow 300 according to an embodiment of the invention is established upon preferences set by the user such as through methods known in the art for selecting factors to associate with each priority of “Junk”, “Low Priority”, “Medium Priority” or “High Priority.”

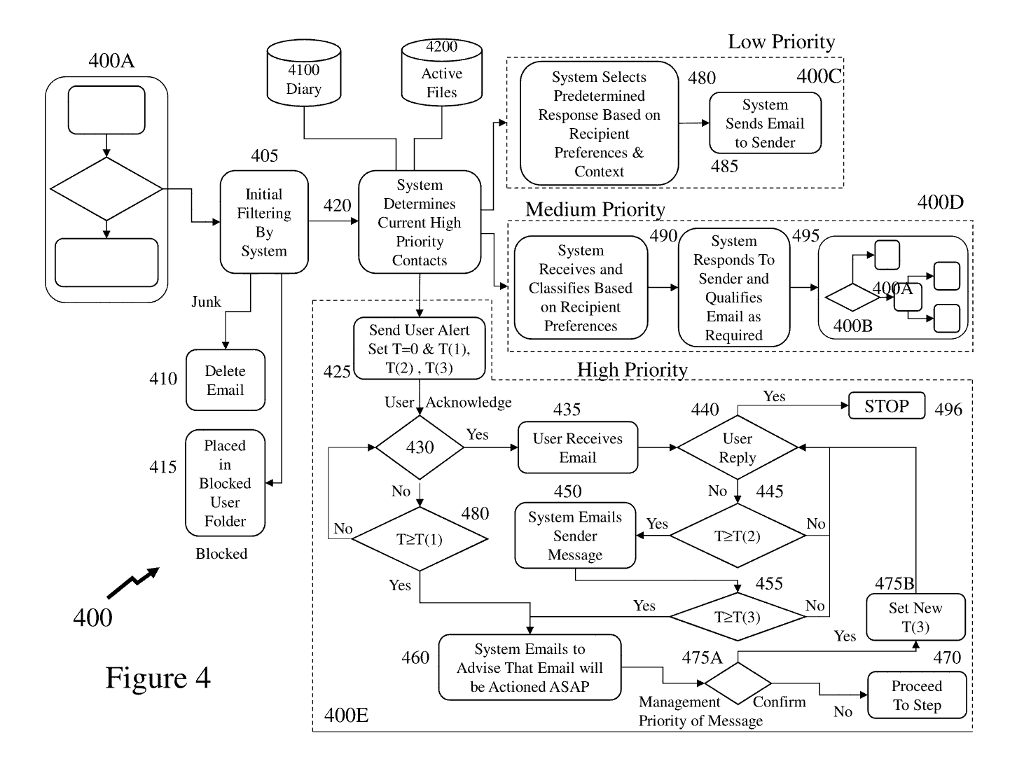

Now referring to FIG. 4 there is depicted a flowchart 400 relating to a recipient side communications model according to an embodiment of the invention executed within an ECS-ECAP wherein initially in first sub-process 400A comprising equivalent steps to steps 305 to step 315 in process flow 300 in FIG. 3. Accordingly, receipt of an email triggers a determination as to whether the system is active or not wherein upon a determination that the system is active the process proceeds to step 405 otherwise it stores the email for subsequent processing. At step 405 initial processing is performed by the ECS-ECAP to determine whether the received email is junk (also known colloquially as spam) or is received from a blocked sender or an address associated with a blocked sender/enterprise/organization etc. In the event of the email being quantified as junk the process proceeds to step 410 and deletes the email whereas for a blocked sender the email is placed within a blocked user folder (or equivalent) for storage in process step 415. If the system determines that the email is not junk or from a blocked sender then the process proceeds to step 420 wherein the process makes a dynamic determination of the email priority based upon one or more sources of context information relating to the recipient including, for example, current date/time, current location of the user, location of the sender, a current activity of the user (recipient), active files the user (recipient) is associated with, and upcoming deadlines for active files the user is working upon. For example, the current date and time are Jan. 16, 2017 and 11:30 am where the recipient is in New York, USA and has 2 residential properties due to close that day. Accordingly, an email from a sender in Calcutta, India relating to a general enquiry is quantified as a lower priority than another email from the seller of one of the properties closing that day. However, an email from a client due to meet the user at 11:45 am may over-ride both or the system may prioritise activities relating to closing, document execution, electronic fund transfers etc. as high priority.

Accordingly, the ECS-ECAP upon identifying the intended recipient of the email extracts appropriate context information from a plurality of databases including, but not limited to, Diary 4100 and Active Files 4200 depicted in FIG. 4. The ECS-ECAP executing the process flow 400 accordingly directs the email to one of third, fourth, and fifth sub-flows 400C to 400E respectively, namely:
“Low Priority” 400C comprising steps 480 and 485 respectively;
“Medium Priority” 400D comprising steps 490 and 495 respectively with second sub-flow 400B; and
“High Priority” 400E comprising steps 425 to 475 respectively.

Considering “Low Priority” 400C process sub-flow in process flow 400 then the system initially selects in step 480 a predetermined response based upon the recipient preferences and context. Recipient preferences may, for example, include the style of response, e.g. formal or informal, signature form etc. whereas context determines for example whether the response indicates some sense of time relating to when response may be given, whether recipient out of office etc. Then in step 485 the process proceeds to send the email in step 485 and terminate.

Now referring to “Medium Priority’ 400D the process sub-flow in process flow 400 then the system initially performs a classification process in step 490 based upon processing of the email received before sending a response to the sender in step 495 before proceeding to step 400B which comprises an equivalent process to steps 385 to 395C respectively wherein based upon the classification the system creates either a task or a calendar entry for the user to follow up on the email.

Referring to “High Priority’400E the process sub-flow in process flow 400 then the system initially performs an initialization in step 425 by setting (initializing) a timer, T=0 , and setting time limits T(1), T(2), and T(3) as well as sending an alert to the recipient. In step 430 the process checks for an acknowledgement wherein if none is received the process loops via step 480 which determines whether the first time T(1) has been reached, e.g. T(1)=15 minutes. If T(1) has not been exceeded the process loops to step 430 otherwise the process proceeds to step 460. If the user acknowledges then the user receives the email n step 435 wherein the process proceeds to step 440 wherein it is determined whether the user replies or not. If the user replies the process proceeds to stop at step 496. If the user has received the email but not replied the process proceeds to step 445 wherein a determination is made as whether a second time T(2) has been reached or not, e.g. T(2)=30 minutes. If not, the process loops back to step 440 wherein it has been exceeded then the process proceeds in step 450 to send the sender an email wherein a determination is made as to whether a third timer T(3) has been exceeded, e.g. T(3)=60 minutes. If not, the process loops back to step 440 otherwise it proceeds to step 460 wherein the system emails the sender indicating that the email will be actioned as soon as possible and then proceeds to step 475A. At step 475 the priority of the message is confirmed wherein if it is maintained then a new T(3) is established in step 475B and the process proceeds back to step 440.

Optionally, one or more steps selected from the group comprising step 405, step 420, step 425, and step 490 in FIG. 4 may be executed by either the ECS-ECAP or an operator. Optionally, the operator may apply for some communication channels, e.g. telephone and social media postings, and not others, e.g. text and email. The operator may be within the organization exploiting the ECS-ECAP or it may be a service provider and/or third-party service provider providing an outsourced function for the organization.

Within embodiments of the invention depicted in respect of ECS-ECAPs in process flows 300 and 400 provide an enterprise, user, users, etc. with a means to filter incoming emails based upon static or dynamic context data respectively. The inventors refer to the ECS-ECAP of process flow 300 as static in that the recipient preferences are established by the user/recipient and only updated whenever the recipient remembers to do so, or another individual does so for the recipient. In contrast ECS-ECAP of process 400 as dynamic in that the recipient preferences are established both in combination with user established preferences but also through additional context sources such as time/date, location, diary, active files, deadlines etc. established through accessing multiple databases linked to the ECS-ECAP.

Whilst the embodiments of the invention depicted in respect of ECS-ECAPs in process flows 300 and 400 provide an enterprise, user, users, etc. with a means to filter incoming emails based upon static or dynamic context data respectively it would be evident that the same process flows may be applied to other electronic communications such as SMS, text, postings, etc. wherein each different communication channel type is formatted by a front end processor such that all messages are routed through a common protocol but which now includes information relating to the received message type. Accordingly, the recipient user may receive the initial alert notification as a text (SMS) message and then receives the forwarded message as an email based upon their responding to the text. Accordingly, the ECS-ECAP may provide the user upon receiving the forwarded message with options established in dependence upon one or more factors including, but not limited to, the electronic device the user receives the forwarded message upon and the contact information relating to the sender which may be either that provided within the original message from the user or extracted from one or more databases associated to the ECS-ECAP such as contact management database or one of LM, SM, and CRM software tools. These options may include, responding to the sender via the same communication channel that they initially communicated via, e.g. reply by telephone for a telephone message, or via a different communications channel, e.g. by email for a telephone message. Optionally, the ECS-ECAP may support text-to-voice functionality allowing the user to generate a message keyboard which is provided to the user via synthesized voice either a default voice from a plurality selected by the recipient for example or one established based upon vocalizations provided by the user to the ECS-ECAP during an initialization process as a new user.

It would be evident that the ECS-ECAP allows a MSME to exploit existing channels of communication, e.g. telephony, mobile telephony, pager, and email, for example, and subsequently newer channels such as text and SMS, as well as allowing postings to user social media accounts, etc. Subsequently, if new channels of contact are added then these may be offered within the appropriate sections of the ECS-ECAP, such as agent profiles, allowing the new channel to be added to one or agents.

It would be evident that the contextual determination of senders whose messages are high priority in ECS-ECAP depicted with process flow 400 provides an increased dynamic filtering to the communication model. Accordingly, the ECS-ECAP adapts to changes in the MSME/organization as they occur such that the advancement of a closing in a real estate transaction from tomorrow to today raises the likelihood that the messages received relating to it are indicated high priority rather than medium priority as other activities today take precedence. However, in addition to context data options described and discussed supra so-called “global” priority settings may be established by the organization that absent other factors would make these communications higher priority generally. For example, a realtor handling commercial real estate may establish major clients as having such global priority such that a message from a national client has higher priority than a regional client.

Within the embodiments of the invention described and depicted supra in respect of ECS-ECAPs within FIGS. 3 and 4 the process flows were considered from the point of view of a single recipient. However, electronic communications such as texts may be sent to multiple individuals simultaneously and emails may be sent not only to multiple individuals but also copied visibly (via carbon copy, cc) and invisibly (blind carbon copy, bcc). Accordingly, an ECS-ECAP may be established into different “modes” by MSMEs etc. such that for example different scenarios can be considered, including, but not limited to:
Scenario A: Multiple Recipients in “To” wherein prioritization is established based upon the highest priority established for each of the recipients and employed for all recipients;
Scenario B: Multiple Recipients in “To” wherein prioritization is established individual for each recipient;
Scenario C: Multiple Recipients in “To” and recipient(s) in “Cc” wherein prioritization is established based upon the highest priority established for each of the recipients and employed for all recipients; and
Scenario D: Multiple Recipients in “To” and recipient(s) in “Cc” wherein prioritization is established individual for each recipient which can provide a higher priority to a copied recipient than an intended recipient.

Optionally, the user alert may include indications of the other recipients and their assigned priority such that the user may receive, for example, a high priority notification indicating that none of the other recipients are receiving it as high priority for example due to their current contexts relative to the sender of the email. Such indication(s) of priority status assigned may be included within the email, for example, such that recipients are colour coded according to priority or have symbols assigned etc. using methods known in the art.

Optionally, where the system triggers a message to the sender with multiple recipients than the message may be generic in that it states something similar to “all recipients have been notified and as soon as one is able to respond they will.” Alternatively, it may provide additional information to the sender such that, for example, an email to “Bob” and “Mary Jane” the response states “Bob and Mary Jane have received your message, but Mary Jane is currently out of the office working with another client” as the context information is woven into the response. In this manner an ECS-ECAP according to an embodiment of the invention can provide a dynamic response to received emails rather than the “static” methodology in the prior art within email of turning on or off an “Out of Office” message. Further, an ECS-ECAP according to embodiments of the invention may provide automated responses to texts, postings etc. which are today not implemented within commercial and consumer communications applications.

Within embodiments of the invention the timers, such as T(1), T(2), and T(3) in FIG. 4, may be established in dependence upon one or more factors including, but not limited to, system defaults, MSME defaults, organization defaults, intended recipient, context of intended recipient, number of high priority messages currently pending with the intended recipient, etc.

Within embodiments of the invention the ECS-ECAP may dynamically manage the electronic messages pending for a recipient such that, for example, if the recipient is employing a smartphone it depicts N, e.g. N=10,20, . . . ALL wherein these may be only high priority emails with links to other folders/inboxes for medium priority and low priority or all messages with them sorted by priority and received time such that if a recipient clears all high priority messages then they can view the medium priority etc.

It would be evident that embodiments of the invention may also support multiple inboxes for user wherein these are permanently associated to the recipient or temporarily associated to the recipient.

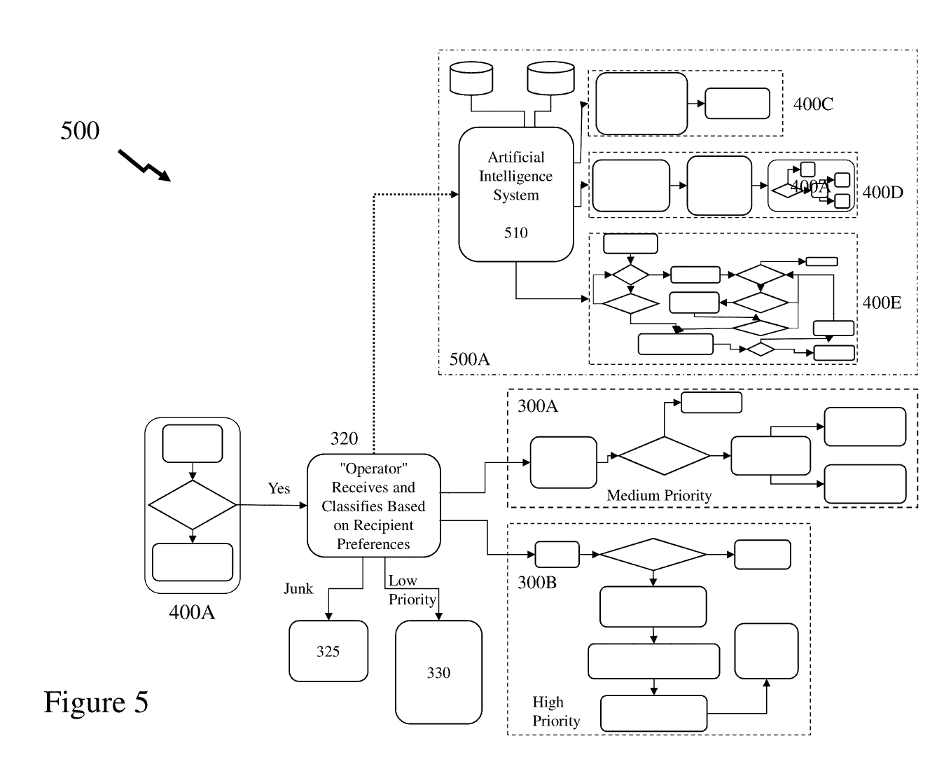

It would be evident that the particular language, priorities, etc. of one organization may be different to another even where they are both within the same commercial/industrial sector. For example, two realtor offices within the same geographical location may have different language, prioritizations, communications flow etc. Accordingly, in some embodiments of the invention it will be beneficial to introduce a layer of artificial intelligence (AI) in parallel to an initial process. Such a configuration is depicted within FIG. 5 wherein there is depicted an initial process similar to that depicted in FIG. 3, for example, with a receipt block 400A, classification step 320, and result steps and process flows 325, 330, 300A and 300B wherein an AI 500A takes the results of the “human” classifier and exploits these as training sets for establishing an automatic qualifier/classifier process such that it classifies to a process similar to that depicted in FIG. 4, for example, wherein the AI System 510 establishes classifications for process flows 400C, 400D and 400E. Optionally, the AI System 510 may be monitored by the “operator” such that incorrect classifications are identified and the correct classification then re-employed in the training sets of the AI System 510. Subsequently the AI System 510 may take over and then provide the classification/decision making functions wherein it exploits outcomes from its actions as data for subsequent training sets to refine and improve its classifications. Optionally, the AI System 510 may be provided with an interface allowing new processing rules to be added or associations of employees/managers to specific actions adjusted to reflect promotions, new employees, departures etc.

Accordingly, the initial training phase is undertaken during by AI 500A as an overlay to the initial deployed or existing system so that the same technology and practices may be applied to different industrial contexts within similar industries such as real estate, mortgage brokers, title insurance reps, insurance brokers, etc. as well as others. Accordingly, an initial classifier set for the AI 500 may be derived from a business or businesses within an allied sector or the training set derived from nothing by operations of the business/enterprise.

Optionally, the system as described and depicted may be initially licensed by MSME or large business wherein the “operator” is provided by a third party service provider, service provider, etc. who manages the inbound communications for the enterprise based upon an initial consultation/definition phase such that the third party “operators” provide the required classification and management initially to benefit the enterprise/business but then are subsequently evolved out of the daily operations as the AI processes reach acceptable levels of matching the “human operator” classification allowing the system to them automatically operate such that the “operator” is then assigned to another enterprise/business to aid in the setup of their system.

Accordingly, as the processes of establishing wide scale learning about human interactions with inbound electronic communication continues commonalities can be established and embedded into the AI based upon keywords, timing of messages relative to calendar entries etc. so that an initial AI may be employed removing the initial operator stage which would be particularly beneficial in applying the methodologies and systems according to embodiments of the invention to individuals within their personal life and small groups such as families etc. where the overhead of establishing a training set from nothing might prove onerous. Although, it would be feasible for the AI to begin with a user's actions from initial initialization onwards. Accordingly, the AI system 500A may become a personal “assistant” providing the appropriate filtering/prioritization of inbound communications for the user. Such an evolution would also support seamless migration from “personal” to “work” environments for users as time—context—calendar factors drive classifications for their personal inbound communications and work communications.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
automatically receiving an electronic message from a sender to be provided to a recipient;
assigning a priority to the electronic message in dependence upon a context of the recipient established by a server upon which the electronic message is received; and
establishing a messaging process from a plurality of messaging processes in dependence upon the priority assigned to the received electronic message.

2. The method according to claim 1, wherein
the context of the recipient is established in dependence upon at least one a time of receipt, a date of receipt, an activity linking the sender and the recipient, a deadline associated with an activity linking the sender and the recipient, a diary associated with the recipient, and a calendar associated with the recipient.

3. The method according to claim 1, wherein
the context of the recipient is established in dependence upon preferences of the recipient.

4. The method according to claim 1, wherein
the priority is assigned by an operator in dependence upon the presentation of context data relating to the recipient to the operator, the context data relating to at least one of an activity linking the sender and the recipient, a deadline associated with an activity linking the sender and the recipient, a diary associated with the recipient, and a calendar associated with the recipient.

5. The method according to claim 1, wherein
the priority is assigned by an operator in dependence upon the presentation of context data relating to the recipient to the operator, the context data relating to preferences of the recipient established by the recipient.

6. The method according to claim 1, wherein
assigning a priority to the electronic message comprises a first stage relating to unwanted messages or blocked senders and a second stage associating with selecting the messaging process based upon the priority being assigned through a selection by an operator from a menu, each option within menu relating to a predetermined messaging process of the plurality of messaging processes.

7. The method according to claim 1, wherein
assigning the priority to the electronic message comprises establishing multiple recipient priorities, each recipient priority established for each intended recipient of the electronic message based upon the specific context of that intended recipient; and
establishing the messaging process from the plurality of messaging processes comprises establishing the messaging process in dependence upon either the highest priority of the multiple recipient priorities and applying that messaging process to all intended recipients or applying each messaging process associated with each intended recipient.

8. A method of prioritizing an electronic communication comprising:
receiving the electronic communication for a sender for transmittal to an intended recipient;
assigning each electronic communication received to a messaging process; wherein
the messaging process is established in dependence upon a current context of the intended recipient.

9. The method according to claim 8, wherein
the intended recipient is one of a plurality of recipients of the electronic communication;
the messaging process established has a priority; and
the recipient can view the priorities of the other recipients of the received electronic communication.

10. The method according to claim 8, wherein
the sender of the electronic communication to the intended recipient is provided with a response established in dependence upon the current context of the intended recipient.

11. The method according to claim 8, wherein
the priority of the messaging process established is established upon the current context of the intended recipient at the time of receipt of the electronic communication for assigning to the messaging process.

12. A method of presenting electronic communications to a user comprising:
automatically receiving electronic messages from senders to be provided to a recipient;
assigning to each received electronic message a priority established in dependence upon a context of the recipient established by a server at the time of receipt of the received electronic message;
assigning each received electronic message to a messaging process of a plurality of messaging processes in dependence upon the priority assigned to the received electronic message; and
providing the user with those received electronic messages within a predetermined messaging process having the highest priority.
